(19) United States
(12) Patent Application Publication
(10) Pub. No.: US 2009/0072746 A1
(43) Pub. Date: Mar. 19, 2009

(54) RESONANT IGNITOR CIRCUIT FOR LAMP WITH A VARIABLE OUTPUT CAPACITANCE BALLAST

(75) Inventors: Jerzy J. Janczak, Eindhoven (NL); Oscar J. Deurloo, Rosmalen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,509

(22) PCT Filed: Oct. 19, 2005
(86) PCT No.: PCT/IB05/53430

§ 371 Date: Apr. 19, 2007

Related U.S. Application Data
(60) Provisional application No. 60/620,449, filed on Oct. 20, 2004.

(51) Int. Cl. H05B 41/288

(52) U.S. Cl. 315/106

(57) ABSTRACT

A resonant igniter circuit (11) employs a switch ignition branch and a resonant ignition branch. The switch ignition branch includes a pair of ignition switches (M1, M2) connected in series with a switch node (N1). The resonant ignition branch includes an ignition coil (L2) and an ignition transformer (T2). Ignition coil (L2) is connected in series with switch node (N1) and a primary winding of ignition transformer (T2). In operation, a serial inductance of ignition coil (L2) is at least fifty (50) times greater than a resonant inductance of ignition transformer (T2) and ignition transformer (T2) has an air-gapped core between a primary winding and a secondary winding to thereby facilitate an impedance of a power stage of the resonant ignition branch as seen from a source as always being inductive over an entire range of output capacitance.

The present invention generally relates to a driver device for a gas discharge lamp (e.g., a high intensity discharge lamp). The present invention specifically relates to a resonant igniter employed within a half-bridge commutating forward stage (“HBCF”) type of a lamp driver capable of igniting the lamp in remote ballasting condition up to 20 meters.

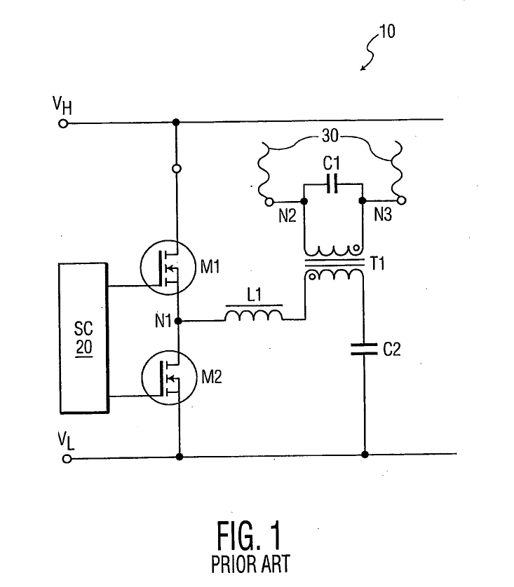

European Patent Application Serial No. 04100731.1, which is incorporated herein by reference in its entirety and is assigned to the assignee of the present application, teaches a resonant igniter circuit 10 as illustrated in FIG. 1. As shown, a switch ignition branch of resonant igniter circuit 10 employs a pair of ignition switches M1 and M2 (e.g., MOSFETs) connected in series with a switch node N1 between a pair of power input rails V_{H} and V_{L}. A resonant ignition branch of resonant igniter circuit 10 employs an ignition capacitor C1 (e.g., 2200 pF), an ignition transformer T1 with primary magnetizing inductance Lₘ (e.g., 5 μH), an ignition coil L1 (e.g., 120 μH) and a storage capacitor C2 (e.g., 220 nF). Ignition transformer T1 has a magnetic core with a 1:7 turns ratio of a primary winding and a secondary winding, which are 180° out of phase. Ignition capacitor C1 and the secondary winding of ignition transformer T1 are connected in parallel between a pair of resonant output nodes N2 and N3. Ignition coil L1, the primary winding of ignition transformer T1 and storage capacitor C2 are connected in series between switch node N1 and a power input rail V_{L}.

In operation, a DC supply voltage is applied between power input rails V_{H} and V_{L} (e.g., 400 V≦ V_{H}−V_{L}≦ 500 V), and an ignition switch controller (“SC”) 20 conventionally switches ignition switches M1 and M2 in a complimentary manner between a conductive state and a non-conductive state at a switch frequency F_{S}. As is well known, a transformer voltage across ignition transformer T1 is at a maximum amplitude whenever switching frequency F_{S} equals a resonance frequency F_{R} of the resonant ignition branch. As such, any frequency sweep of resonant igniter circuit 10 as controlled by ignition switch controller 20 should be inclusive of resonance frequency F_{R} of the resonant ignition branch. However, a ballast is connected to the lamp from nodes N2, N3 via ballast cables 30 to facilitate a remote ballasting of a lamp (not shown) being ignited by resonant igniter circuit 10. Consequently, ballast cables 30 can introduce additional output capacitance (e.g., 100 pF/M) to the resonant ignition branch of resonant igniter circuit 10 whereby the resonance frequency F_{R} of the resonant ignition branch would be reduced to an unknown degree. Furthermore, any loose contact between nodes N2, N3 and the ballast can introduce very rapid and random changes to the output capacitance. Such a rapid change of the output capacitance may lead to a loss of zero voltage switching (“ZVS”) of switches M1 and M2 and self destruction due to overheating.

The lighting industry is therefore continually striving to improve upon the existing technology related to remote ballasting of a lamp ignited by a resonant lamp igniter (e.g., reson ant igniter circuit 10) employed within a HBCF type of a driver device.

To this end, the present invention provides new and unique structural configurations of a resonant lamp igniter that ensures ZVS of switches under variable capacitive loads by ensuring the impedance of a power stage as seen from a source is always inductive over an entire range of output capacitance.

One form of the present invention is a resonant igniter circuit employing a switch ignition branch and a resonant ignition branch. The switch ignition branch includes a pair of ignition switches connected in series with a switch node. The resonant ignition branch includes an ignition coil and an ignition transformer. The ignition coil is connected in series with the switch node and a primary winding of ignition transformer. In operation, the resonant ignition branch facilitates an impedance of a power stage of the resonant ignition branch as seen from a source as always being inductive over an entire range of output capacitance. A serial inductance of the ignition coil is at least fifty (50) times greater than a resonant inductance of ignition transformer and/or the ignition transformer has an air gap between a primary winding and a secondary winding to create an air-gapped core and thereby facilitate an impedance of a power stage of the resonant ignition branch as seen from a source as always being inductive over an entire range of output capacitance.

A second form of the present invention is a ballast employing an ignition switch controller, and the aforementioned resonant igniter circuit. The ignition switch controller is operable to switch the switches of the resonant lamp igniter in a complimentary manner between a conductive state and a non-conductive state over a specified frequency range.

A third form of the present invention is driver device employing the aforementioned resonant igniter circuit, and a steady-state lamp driver. The resonant igniter circuit, and the steady-state lamp driver facilitate an ignition and a steady state operation of a lamp.

The foregoing forms as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

FIG. 1 illustrates a resonant igniter circuit as known in the art;

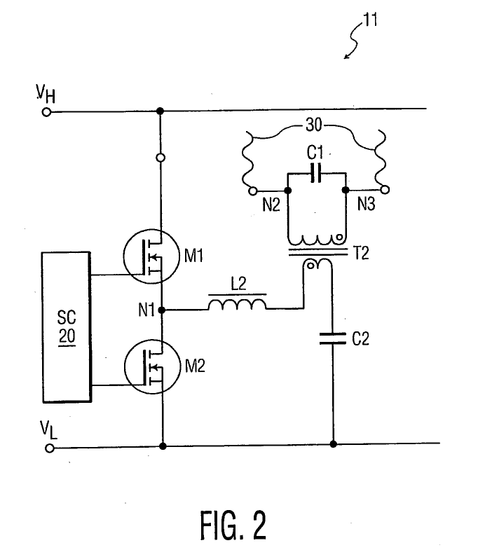

FIG. 2 illustrates one embodiment of a resonant igniter circuit in accordance with the present invention;

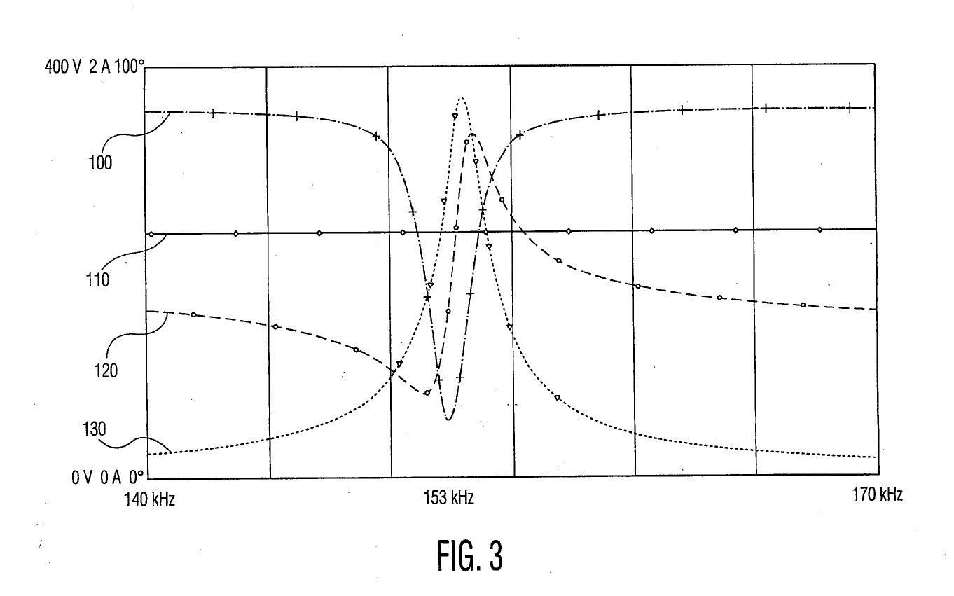

FIGS. 3-5 illustrate a first exemplary frequency sweep of the FIG. 2 resonant igniter circuit;

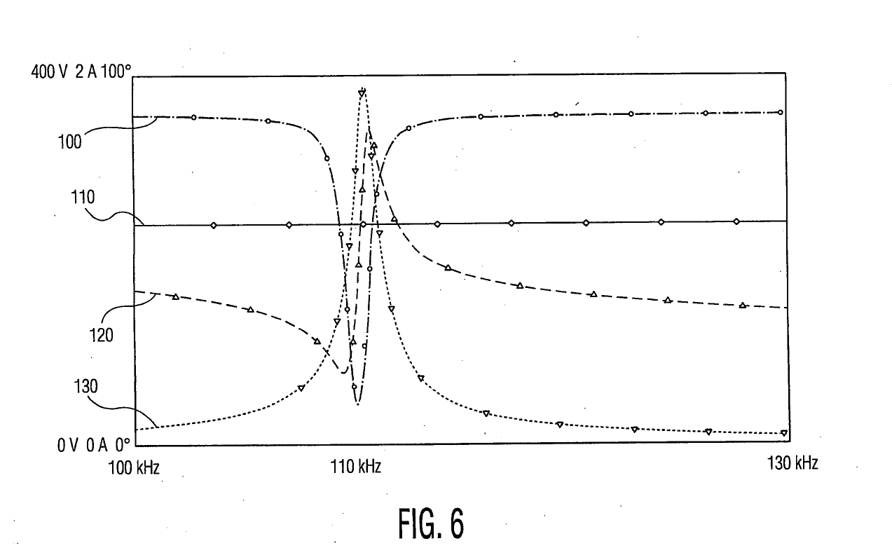

FIGS. 6-8 illustrate a second exemplary frequency sweep of the FIG. 2 resonant igniter circuit; and

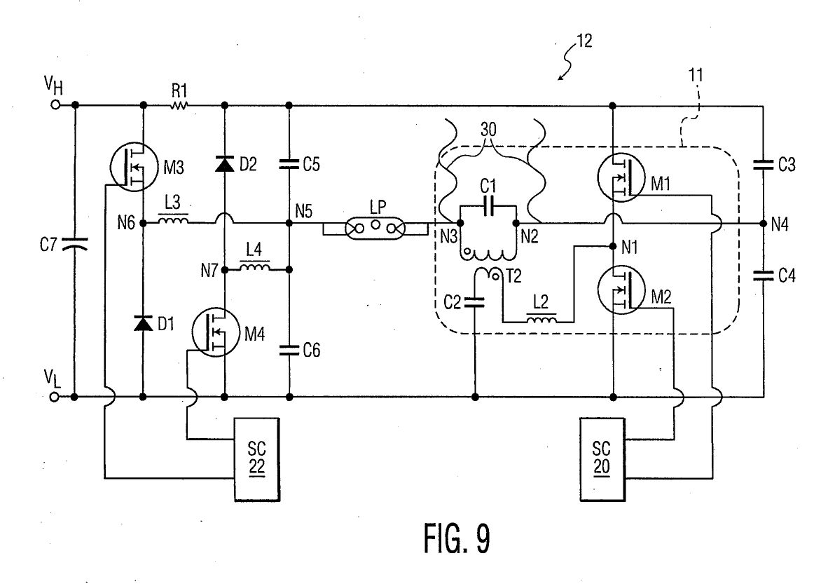

FIG. 9 illustrates one embodiment of a lamp driver in accordance with the present invention.

One inventive aspect of the present invention is to have a serial inductance L_{S} of an ignition coil to dominate a resonant inductance L_{M} of an ignition transformer whereby ZVS is achieved of a specified frequency range irrespective of output capacitance. In one embodiment, L_{S}≧50 L_{M} whereby ZVS is achieved of a specified frequency range irrespective of output capacitance.

A second inventive aspect of the present invention is to employ an ignition transformer having a considerable air gap to create an air-gapped core and thereby facilitate desirable values of the resonant inductance L_{M} of the ignition transformer that facilitates the dominance of the serial inductance L_{S} of an ignition coil over the resonant inductance L m of the ignition transformer.

A third inventive aspect of the present invention is to implement a frequency sweep back and forth over a frequency range covering an entire resonant ignition characteristic of the resonant lamp igniter.

The following descriptions of FIGS. 2 and 3 provide exemplary embodiments of the present invention incorporating one or more of the aforementioned inventive aspects of the present invention.

FIG. 2 illustrates a resonant igniter circuit 11 having a switch ignition branch and a resonant ignition branch. The switch ignition branch of resonant igniter circuit 11 employs ignition switches M1 and M2 (e.g., MOSFETs) as previously described herein. The resonant ignition branch of resonant igniter circuit 11 employs an ignition capacitor C1 (e.g., 2200 pF), an ignition transformer T2 (e.g., 5 uH), an ignition coil L2 (e.g., 120 μH) and a storage capacitor C2 (e.g., 150 nF). A core of ignition transformer T2 has an air gap with a 1:6 turns ratio of a primary winding and a secondary winding, which are 180° out of phase. Ignition capacitor C1 and a secondary winding of ignition transformer T2 are connected in parallel between a pair of resonant output nodes N2 and N3. Ignition coil L2, a primary winding of ignition transformer T2 and storage capacitor C2 are connected in series between switch node N1 and a power input rail V_{L}.

In operation, a DC supply voltage is applied between power input rails V_{H} and V_{L} (e.g., 400 V≦V_{H}−V_{L}≦ 500 V), and an ignition switch controller 20 conventionally switches ignition switches M1 and M2 in a complimentary manner between a conductive state and a non-conductive state in accordance with a frequency sweep covering an entire resonant ignition characteristic of the resonant igniter for a specified period of time (e.g., 0.2-5.0 seconds).

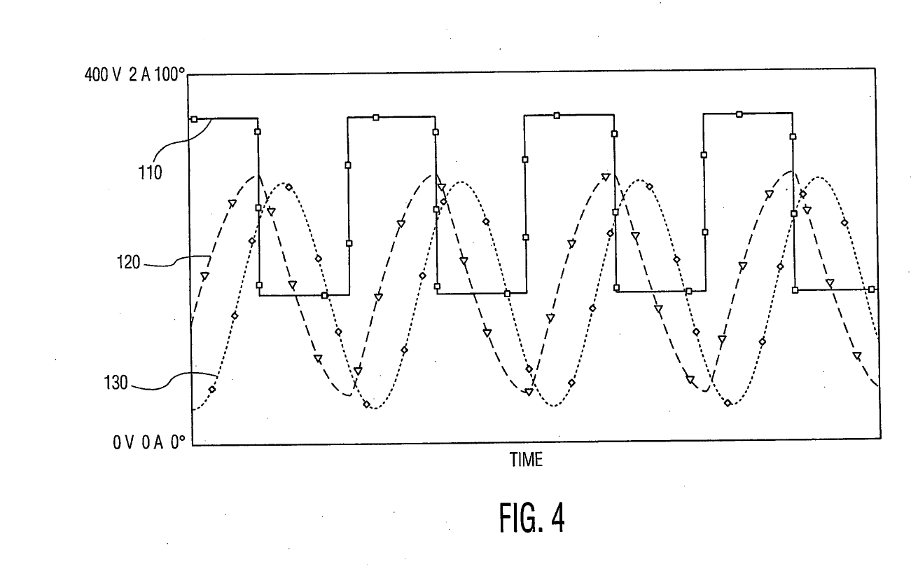

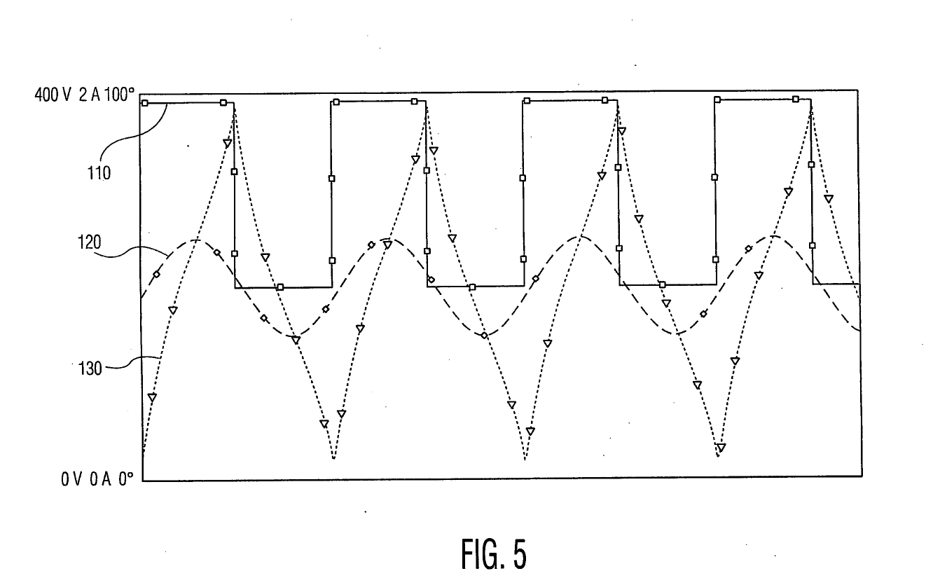

For example, FIG. 3 illustrates an input voltage 110, a source current 120 and an output voltage 130 for resonant igniter circuit 11 operating at a resonant frequency of 153 kHz over a frequency sweep of 140 kHz to 170 kHz, where resonant frequency 153 kHz corresponds to a base output capacitance. A phase 100 of the impedance as seen from the source is also plotted in FIG. 3. Additionally, FIG. 4 illustrates input voltage 110, source current 120 and output voltage 130 in a time domain for resonant igniter circuit 11 operating at a resonant frequency of 154 kHz, and FIG. 5 illustrates input voltage 110, source current 120 and output voltage 130 in a time domain for resonant igniter circuit 11 operating at a resonant frequency of 150 kHz.

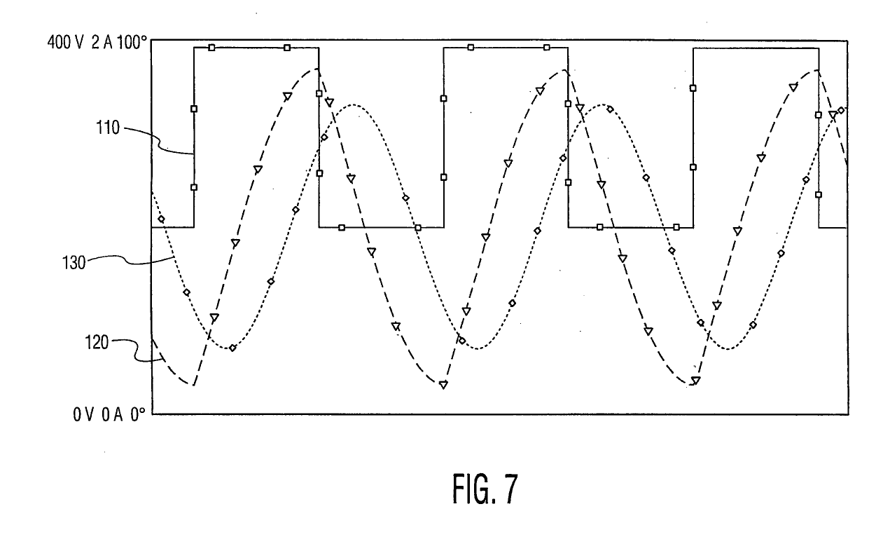

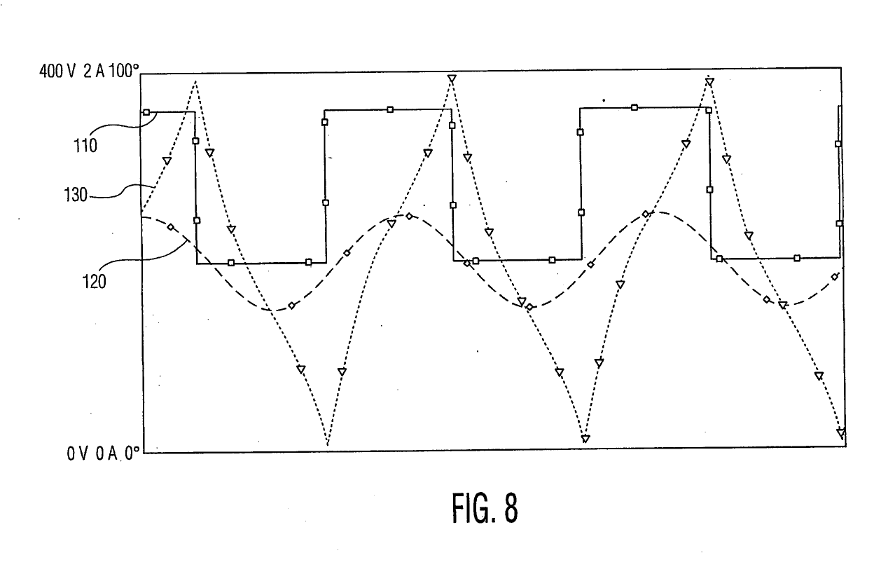

Also by example, FIG. 6 illustrates input voltage 110, source current 120 and output voltage 130 for resonant igniter circuit 11 operating at a resonant frequency of 110 kHz over a frequency sweep of 100 kHz to 130 kHz, where resonant frequency 110 kHz corresponds to a ΔC= 2.0 nF increase to the base output capacitance. Again, phase 100 of the impedance as seen from the source is also plotted in FIG. 6. Additionally, FIG. 7 illustrates input voltage 110, source current 120 and output voltage 130 in a time domain for resonant igniter circuit 11 operating at a resonant frequency of 111 kHz, and FIG. 8 illustrates input voltage 110, source current 120 and output voltage 130 in a time domain for resonant igniter circuit 11 operating at a resonant frequency of 109 kHz.

FIG. 9 illustrates a lamp driver 12 incorporating resonant igniter circuit 11 and a steady-state lamp driver for facilitating an ignition and steady-state operation of a lamp. To this end, one end of a lamp LP (e.g., a HID lamp) is connected to resonant node N3, and a filter capacitor branch employs a pair of capacitors C3 and C4 (e.g., 150 uF) connected in series with a filter node N4, which is connected to resonant node N2. Capacitor C3 is further connected to power input rail V_{H} via resistor R1, and capacitor C4 is further connected to power input rail V_{L}.

The other end of lamp LP is connected to driving node N5. A capacitor drive branch employs a pair of capacitors C5 and C6 (e.g., 1.0 uF) connected in series with driving node N5. Capacitor C5 is further connected to power input rail V_{H} via resistor R1, and capacitor C6 is further connected to power input rail V_{L}.

A steady state switch branch employs a switch M3 (e.g., a MOSFET) and a diode D1 connected in series with a switch node N6, which is connected to drive node N5 via a drive inductor L3 (e.g., 100 uH). Switch M3 is further connected to power input rail V_{H}, and diode D1 is further connected to power input rail V_{L}.

An additional steady state switch branch employs a diode D2 and a switch M4 (e.g., a MOSFET) connected in series with a switch node N7, which is connected to drive node N5 via a drive inductor L4 (e.g., 100 uH). Diode D2 is further connected to power input rail V_{H} via resistor R1, and switch M4 is further connected to power input rail V_{L}.

A buffer capacitor C7 (e.g., 150 uF) is connected to power input rails V_{H} and V_{L}.

To ignite lamp LP, an ignition voltage (e.g., 3 kV≦V_{H}−V_{L}≦ 4 kV) is applied between resonant output nodes N3 and N2 and consequently the same voltage is applied between nodes N3 and N5. An ignition switch controller 20 conventionally switches ignition switches M1 and M2 in a complimentary manner between a conductive state and a non-conductive state in accordance with a frequency sweep covering an entire resonant ignition characteristic of the resonant igniter for a specified period of time (e.g., 0.2-5.0 seconds).

To operate lamp LP in a steady-state manner, a drive voltage (e.g., 100 V≦V_{H}−V_{L}≦ 107 V), is applied between nodes N3 and N5 and a drive switch controller 22 conventionally switches ignition switches M3 and M4 in a complimentary manner between a conductive state and a non-conductive state at a steady-state frequency or frequency range. During this steady-state operation, ignition switch controller 20 can also conventionally switch ignition switches M1 and M2 in a complimentary manner between a conductive state and a non-conductive state at the steady-state frequency or frequency range.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A resonant igniter circuit (11), comprising:
a switch ignition branch including a first ignition switch (M1) and a second ignition switch (M2) connected in series with a switch node (N1); and
a resonant ignition branch connected to the switch node (N1), the resonant ignition branch including an ignition coil (L2) and an ignition transformer (T2) connected in series, wherein an impedance of a power stage of the resonant ignition branch as seen from a source is inductive over an entire range of output capacitance of the resonant ignition branch.

2. The resonant igniter circuit (11) of claim 1, wherein a serial inductance of the ignition coil (L2) is at least fifty (50) times greater than a resonant inductance of the ignition transformer (T2).

3. The resonant igniter circuit (11) of claim 1, wherein the ignition transformer (T2) includes a primary winding and a secondary winding wound around an air-gapped core.

4. The resonant igniter lamp (11) of claim 1, wherein the first ignition switch (M1) and the second ignition switch (M2) are operable to be connected to an ignition switch controller (20) for switching the first ignition switch (M1) and the second ignition switch (M2) in a complimentary manner between a conductive state and a non-conductive state over a frequency sweep covering an entire resonant ignition characteristic of the resonant lamp igniter (11).

5. The resonant igniter circuit (11) of claim 1,
wherein the resonant ignition branch further includes a storage capacitor (C2); and
wherein the ignition coil (L2), a primary winding of the ignition transformer (T2), and the storage capacitor (C2) are connected in series between the switch node (N1) and a power input rail (V_{L}).

6. The resonant igniter circuit (11) of claim 1,
wherein the resonant ignition branch further includes a resonant capacitor (C1); and
wherein the resonant capacitor (C1) and a secondary winding of the ignition transformer (T2), are connected in parallel.

7. A ballast, comprising:
a resonant igniter circuit (11) including
a switch ignition branch including a first ignition switch (M1) and a second ignition switch (M2) connected in series with a switch node (N1), and
a resonant ignition branch connected to the switch node (N1), the resonant ignition branch including an ignition coil (L2) and an ignition transformer (T2) connected in series wherein an impedance of a power stage of the resonant ignition branch as seen from a source is inductive over an entire range of output capacitance of the resonant ignition branch; and
an ignition switch controller (20) connected to the first ignition switch (M1) and the second ignition switch (M2) to switch the first ignition switch (M1) and the second ignition switch (M2) in a complimentary manner between a conductive state and a non-conductive state over a frequency sweep covering an entire resonant ignition characteristic of the resonant lamp igniter (11).

8. The ballast of claim 7, wherein a serial inductance of the ignition coil (L2) is at least fifty (50) times greater than a resonant inductance of the ignition transformer (T2).

9. The ballast of claim 7, wherein the ignition transformer (T2) includes a primary winding and a secondary winding wound on an air-gapped core.

10. The ballast of claim 7,
wherein the resonant ignition branch further includes a storage capacitor (C2); and
wherein the ignition coil (L2), a primary winding of the ignition transformer (T2), and the
storage capacitor (C2) are connected in series between the switch node (N1) and a power input rail (V_{L}).

11. The ballast of claim 7,
wherein the resonant ignition branch further includes a resonant capacitor (C1); and
wherein the resonant capacitor (C1) and a secondary winding of the ignition transformer (T2), are connected in parallel.

12. A lamp driver (12), comprising:
a resonant igniter circuit (11) including
a switch ignition branch including a first ignition switch (M1) and a second ignition switch (M2) connected in series with a first switch node (N1), and
a resonant ignition branch connected to the first switch node (N1), the resonant ignition branch including an ignition coil (L2) and an ignition transformer (T2) connected in series wherein an impedance of a power stage of the resonant ignition branch as seen from a source is inductive over an entire range of output capacitance of the resonant ignition branch; and
a steady-state lamp driver, wherein the resonant igniter circuit (11) and the steady-state lamp driver are operably connected to ignite and steady-state operate a lamp (LP).

13. The lamp driver (12) of claim 12, wherein a serial inductance of the ignition coil (L2) is at least fifty (50) times greater than a resonant inductance of the ignition transformer (T2) whereby an impedance of the power stage of the resonant ignition branch as seen from the source is inductive over the entire range of output capacitance of the resonant ignition branch.

14. The lamp driver (12) of claim 12, wherein the ignition transformer (T2) includes a primary winding and a secondary winding wound on an air-gapped core.

15. The lamp driver (12) of claim 12, wherein the first ignition switch (M1) and the second ignition switch (M2) are operably connected to an ignition switch controller (20) for switching the first ignition switch (M1) and the second ignition switch (M2) in a complimentary manner between a conductive state and a non-conductive state over a frequency sweep covering an entire resonant ignition characteristic of the resonant igniter circuit (11).

16. The lamp driver (12) of claim 12,
wherein the resonant ignition branch further includes a storage capacitor (C2); and
wherein the ignition coil (L2), a primary winding of the ignition transformer (T2), and the storage capacitor (C2) are connected in series between the switch node (N1) and a power input rail (V_{L}).

17. The lamp driver (12) of claim 12,
wherein the resonant ignition branch further includes a resonant capacitor (C1); and
wherein the resonant capacitor (C1) and a secondary winding of the ignition transformer (T2), are connected in parallel.

18. The lamp driver (12) of claim 17,
wherein the parallel connection of the resonant capacitor (C1) and the secondary winding of the ignition transformer (T2) is connected to a first end of the lamp (LP).

19. The lamp driver (12) of claim 18, wherein the steady-state lamp driver includes
a first drive switch branch including a first drive switch (M3) and a first diode (D1) connected in series with a second switch node (N6);
a first drive coil (L3) connected to the second switch node (N6) and a second end of the lamp (LP);
a second drive switch branch including a second drive switch (M4) and a second diode (D2) connected in series with a third switch node (N7); and
a second drive coil (L4) connected to the third switch node (N7) and the second end of the lamp (LP).

20. The lamp driver (12) of claim 19, wherein the first drive switch (M3) and the second drive switch (M4) are operably connected to a drive switch controller (22) for switching the first drive switch (M3) and the second drive switch (M4) to thereby be switched in a complimentary manner between a conductive state and a non-conductive state.
